(19) United States
(12) Patent Application Publication
(10) Pub. No.: US 2010/0165796 A1
(43) Pub. Date: Jul. 1, 2010

(54) Stepping motor control circuit and analogue electronic watch

(76) Inventors: Kenji Ogasawara, Chiba-shi (JP); Akira Takakura, Chiba-shi (JP); Saburo Manaka, Chiba-shi (JP); Keishi Honmura, Chiba-shi (JP); Takanori Hasegawa, Chiba-shi (JP); Kosuke Yamamoto, Chiba-shi (JP); Kazumi Sakumoto, Chiba-shi (JP); Kazuo Kato, Chiba-shi (JP)

Correspondence Address: BRUCE L. ADAMS, ESQ;ADAMS & WILKS, 17 BATTERY PLACE - SUITE 1231, NEW YORK, NY, 10004, US

(21) Appl. No.: 12/653,538

(22) Filed: Dec. 15, 2009

(30) Foreign Application Priority Data
Dec. 25, 2008 (JP) 2008-330480

(51) Int. Cl. G04B 19/04; H02P 8/38

(52) U.S. Cl. 368/80; 318/696

(57) ABSTRACT

According to a stepping motor control circuit of the invention, a rotation detecting period is divided into a first segment for detecting an induced signal generated at least in a second quadrant by the rotation of a rotor immediately after driving of a main driving pulse, a second segment being provided after the first segment for detecting the induced signal in a third quadrant, and a third segment provided after the second segment and, when a stepping motor detects the induced signal exceeding a reference threshold voltage in the first segment and the second segment, a control circuit controls a pulse down counter circuit to output a pulse down control signal.

### BACKGROUND

1. Technical Field

The present invention relates to a stepping motor control circuit and an analogue electronic watch using the stepping motor control circuit.

2. Description of the Related Art

In the related art, in an analogue electronic watch or the like, a stepping motor including a stator having a rotor storage hole and a positioning portion for determining a stop position of a rotor, the rotor disposed in the rotor storage hole, and a coil, in which the rotor is rotated and the rotor is stopped at a position corresponding to the positioning portion by causing the stator to generate a magnetic flux by supplying alternating signals to the coil is used.

A method employed as a method of controlling the stepping motor is a correction driving system in which whether or not the stepping motor is rotated is detected by detecting an induced signal corresponding to an induced voltage generated in the stepping motor when the stepping motor is driven by a main driving pulse and, depending on whether rotated or not, the main driving pulse is changed to a main driving pulse having a different pulse width for driving the stepping motor, or a correction driving pulse having a pulse width larger than that of the main driving pulse is used for forcedly driving the same (for example, JP-B-61-15385).

In addition to the detection of the induced voltage described in JP-B-61-15385, a correction driving system described in WO2005/119377 is configured to divide a detecting period immediately after the drive by the main driving pulse into a first segment, a second segment after the first segment, and a third segment after the second segment, and control the drive of rotation by a combination of induced voltage signals detected in the respective segments. Accordingly, the state of rotation of the stepping motor is grasped with a high degree of accuracy, and so that an adequate driving pulse according to the state of rotation can be selected for driving.

When it is determined that the rotation is not going on upon receipt of the detected result from a rotation detecting circuit, the pulse up operation is performed and repeated until the driving pulse reaches a value which is capable of driving the rotation of the stepping motor. Also, the pulse down operation is performed at regular intervals to confirm whether or not the excessive pulse up operation is performed. Since a reserved capacity for driving the motor from the time at which the rotation is detected, the pulse down is prohibited when it is determined that there is not enough the reserved capacity for driving.

However, due to variations among the stepping motors, there is a possibility to determine the short of reserved capacity for driving too early and prohibit the pulse down even though the driving pulse of one rank lower is also sufficient for driving, so that consumption of needless electric power may be resulted.

### SUMMARY OF THE INVENTION

It is an aspect of the invention to achieve power saving by grasping the state of driving of the stepping motor further accurately.

According to another aspect of the invention, there is provided a stepping motor control circuit including: a pulse down counter circuit configured to output a pulse down control signal for pulse down controlling of a main driving pulse at a predetermined cycle; a driving pulse generating unit configured to output the main driving pulse or a correction driving pulse corresponding to a pulse control signal, and perform a pulse down operation on the main driving pulse in response to the pulse down control signal; a motor driving unit configured to drive a stepping motor to rotate in response to the driving pulse from the driving pulse generating unit; a rotation detecting unit configured to detect whether or not an induced signal generated within a rotation detecting period by the rotation of the stepping motor exceeds a reference threshold voltage; and a control unit configured to output the pulse control signal for controlling the driving pulse generating unit so as to drive the stepping motor by any one of a plurality of the main driving pulses different in energy from each other or the correction driving pulse having a larger energy than the respective main driving pulses on the basis of the result of detection by the rotation detecting unit, in which the rotation detecting period is divided into a first segment for detecting the induced signal generated in at least a second quadrant, a second segment being provided after the first segment for detecting the induced signal in a third quadrant, and a third segment being provided after the second segment according to the rotation of the rotor immediately after the driving by the main pulse, the control unit controls the pulse down counter circuit so as to be able to output the pulse down control signal only once when the rotation detecting unit detects an induced signal exceeding the reference threshold voltage in the first segment and the second segment, and the driving pulse generating unit outputs the main driving pulse having subjected to the pulse down operation in response to the pulse down control signal from the pulse down counter circuit to the motor driving unit.

the control unit controls the pulse down counter circuit to output the pulse down control signal only once when the rotation detecting unit detects the induced signal exceeding the reference threshold voltage in the first segment and the second segment, and the driving pulse generating unit outputs the main driving pulse having subjected to the pulse down operation in response to the pulse down control signal from the pulse down counter circuit to the motor driving unit.

Preferably, the control unit controls the pulse down counter circuit to output the pulse down control signal when the rotation detecting unit detects the induced signal exceeding the reference threshold voltage in the first segment and the second segment, and outputs the pulse control signal to the driving pulse generating unit to cause the same to output the correction driving pulse, the driving pulse generating unit outputs the main driving pulse having subjected to the pulse down operation in response to the pulse down control signal to the motor driving unit and then outputs the correction driving pulse, and the motor driving unit drives the stepping motor by the main driving pulse in response to the main driving pulse and the correction driving pulse from the driving pulse generating unit, and then drives the same by the correction driving pulse.

Preferably, the control unit outputs the pulse control signal to the driving pulse generating unit so as to output the main driving pulse before the pulse down instead of the correction driving pulse, the driving pulse generating unit outputs the main driving pulse having subjected to the pulse down operation in response to the pulse down control signal to the motor driving unit and then outputs the main driving pulse before the pulse down, and the motor driving unit drives the stepping motor by the main driving pulse having subjected to the pulse down operation and then drives the same by the main driving pulse before the pulse down.

According to another aspect of the invention, there is provided an analogue electronic watch having a stepping motor configured to drive time-of-day hands to rotate, and a stepping motor control circuit configured to control the stepping motor, in which the above-described stepping motor control circuit is used as the stepping motor control circuit.

According to the invention, the driving state of the stepping motor is accurately grasped, so that power saving is achieved.

According to the invention, the analogue electronic watch which achieves power saving is provided by grasping the driving state of the stepping motor accurately.

### BRIEF DESCRIPTION OF THE DRAWINGS

FIG. 1 is a block diagram of an analogue electronic watch according to an embodiment of the invention;

FIG. 2 is a configuration drawing of a stepping motor used in the analogue electronic watch according to the embodiment of the invention;

FIG. 3 is a timing chart for explaining the action of a stepping motor control circuit and the analogue electronic watch according to the embodiment of the invention;

FIG. 4 is a timing chart for explaining the action of the stepping motor control circuit and the analogue electronic watch according to the embodiment of the invention;

FIG. 5 is a timing chart for explaining the action of the stepping motor control circuit and the analogue electronic watch according to the embodiment of the invention;

FIG. 6 is a timing chart for explaining the action of the stepping motor control circuit and the analogue electronic watch according to the embodiment of the invention;

FIG. 7 is a timing chart for explaining the action of the stepping motor control circuit and the analogue electronic watch according to the embodiment of the invention;

FIG. 8 is a determination chart for explaining the action of the stepping motor control circuit and the analogue electronic watch according to the embodiment of the invention;

FIG. 9 is a flowchart showing the action of the stepping motor control circuit and the analogue electronic watch according to the embodiment of the invention;

FIG. 10 is a flowchart showing the action of the stepping motor control circuit and the analogue electronic watch according to the embodiment of the invention;

### DESCRIPTION OF THE PREFERRED EMBODIMENTS

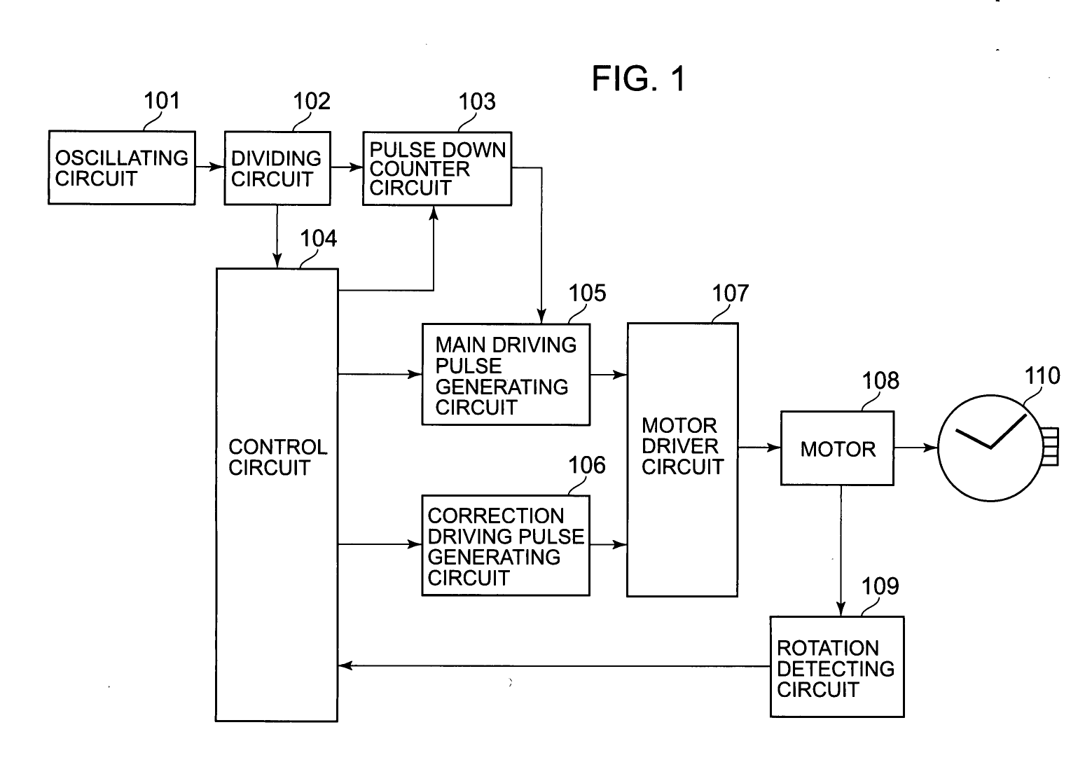

FIG. 1 is a block diagram of an analogue electronic watch using a stepping motor control circuit according to an embodiment of the invention showing an example of an analogue electronic wrist watch.

In FIG. 1, the analogue electronic watch includes an oscillating circuit 101 configured to generate signals of a predetermined frequency, a dividing circuit 102 configured to divide the signals generated in the oscillating circuit 101 and generate clock signals which serves as references of time counting, a control circuit 104 configured to perform control such as control of respective electronic circuit elements which constitute the electronic watch or control of the change of a driving pulse, a pulse down counter circuit 103 configured to output a pulse down control signal for performing the pulse down operation on a main driving pulse when a clock signal from the dividing circuit 102 is counted for a predetermined time period, and a main driving pulse generating circuit 105 configured to select a main driving pulse P1 for driving the rotation of the stepping motor on the basis of the pulse control signal from the control circuit 104 and outputting the same.

The analogue electronic watch includes a correction driving pulse generating circuit 106 configured to output a correction driving pulse P2 for forcedly driving the rotation of a stepping motor 108 on the basis of the pulse control signal from the control circuit 104, a motor driver circuit 107 configured to drive the rotation of the stepping motor 108 in response to the main driving pulse P1 from the main driving pulse generating circuit 105 and the correction driving pulse P2 from the correction driving pulse generating circuit 106, the stepping motor 108, a portable display device 110 driven to rotate by the stepping motor 108 and having time-of-day hands indicating a time of the day, and a rotation detecting circuit 109 configured to detect an induced voltage signal generated according to the rotation of the stepping motor 108 in a predetermined rotation detecting period.

The pulse down counter circuit 103 has a function to output the pulse down control signal to the main driving pulse generating circuit 105 at a predetermined cycle, and is controlled to output the pulse down control signal when prescribed by the control circuit 104.

The control circuit 104 also has a function or the like as a segment determination circuit for comparing a time of the day at which the rotation detecting circuit 109 detects an induced signal exceeding a reference threshold voltage Vcomp and the segment in which the corresponding induced signal is detected by the rotation of the stepping motor 108 and determining which segment the induced signal is detected belongs to. As described later, a rotation detecting period for detecting whether or not the stepping motor 108 is rotated is divided into three segments.

The rotation detecting circuit 109 has the similar configuration to a rotation detecting circuit described in JP-B-61-15385, and detects the induced signal exceeding the predetermined reference threshold voltage Vcomp generated by free vibrations after having driven the rotation of the stepping motor 108.

The oscillating circuit 101 and the dividing circuit 102 constitute a signal generating unit, and an analogue display unit 110 constitutes a display unit. The rotation detecting circuit 109 constitutes a rotation detecting unit, and the control circuit 104 constitutes a control unit. The main driving pulse generating circuit 105 and the correction driving pulse generating circuit 106 constitute a driving pulse generating unit. The motor driver circuit 107 constitutes a motor driving unit.

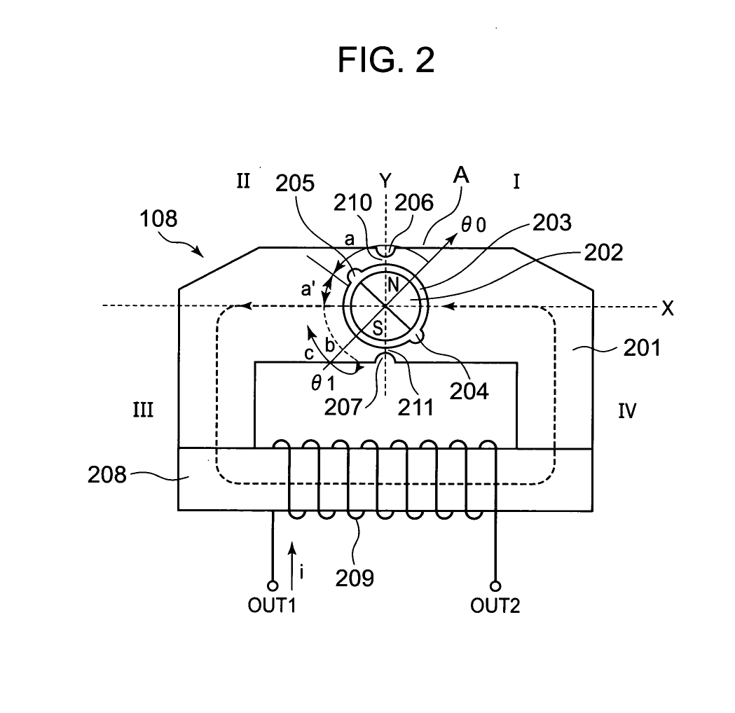

FIG. 2 is a configuration drawing of the stepping motor 108 which is used in the embodiment of the invention, and shows an example of a stepping motor for a watch which is generally used in the analogue electronic watch.

In FIG. 2, the stepping motor 108 includes a stator 201 having a rotor storage through hole 203, a rotor 202 disposed in the rotor storage through hole 203 so as to be capable of rotating therein, a magnetic core 208 joined to the stator 201, and a coil 209 wound around the magnetic core 208. When the stepping motor 108 is used in the analogue electronic watch, the stator 201 and the magnetic core 208 are fixed to a base panel (not shown) with screws (not shown) and are joined to each other. The coil 209 has a first terminal OUT1 and a second terminal OUT2.

The rotor 202 is magnetized in two polarities (S-polar and N-polar). A plurality of (two in this embodiment) notched portions (outer notches) 206 and 207 are provided on outer end portions of the stator 201 formed of a magnetic material at positions opposing to each other with the intermediary of the rotor storage through hole 203.

Provided between the respective outer notches 206 and 207 and the rotor storage through hole 203 are saturable portions 210 and 211.

The saturable portions 210 and 211 are configured not to be magnetically saturated by a magnetic flux of the rotor 202 and to be magnetically saturated when the coil 209 is excited so that the magnetic resistance is increased. The rotor storage through hole 203 is formed into a circular hole shape having a plurality of (two in this embodiment) semicircular notched portions (inner notches) 204 and 205 integrally formed at opposed portions of the through hole having a circular contour.

The notched portions 204 and 205 constitute positioning portions for positioning a stop position of the rotor 202.

A space where the rotor 202 rotates is divided into four quadrants (a first quadrant I to a fourth quadrant IV) about an axis of rotation of the rotor 202.

In a state in which the coil 209 is not excited, the rotor 202 is stably stopped at a position corresponding to the above-described positioning portions, in other words, at a position where an axis of magnetic pole A of the rotor 202 extends orthogonally to a segment connecting the notched portions 204 and 205 (a predetermined angular position θ0 with respect to the direction X of magnetic flow) as shown in FIG. 2.

When the motor driver circuit 107 supplies a rectangular driving pulse between terminals OUT1 and OUT2 of the coil 209 (for example, driving with a first polarity signal in which the first terminal OUT1 side is the positive pole and the second terminal OUT2 side is the negative pole), and allow a current i to flow in the direction indicated by an arrow in FIG. 2, a magnetic flux in the direction of an arrow of a broken line is generated in the stator 201. Accordingly, the saturable portions 210 and 211 are saturated, and the magnetic resistance is increased, and then the rotor 202 rotates in a normal direction (counterclockwise in FIG. 2) by 180° by a mutual action between a magnetic pole generated in the stator 201 and a magnetic pole of the rotor 202, and the axis of magnetic polarity stops stably at an angular position θ1.

Subsequently, when the motor driver circuit 107 supplies a rectangular driving pulse having an opposite polarity from the first polarity between terminals OUT1 and OUT2 of the coil 209 (driving with a second polarity signal in which the first terminal OUT1 side is the negative pole and the second terminal OUT2 side is the positive pole), and allow a current to flow in the direction opposite from the direction indicated by the arrow in FIG. 2, a magnetic flux in the direction opposite from the arrow of the broken line is generated in the stator 201. Accordingly, the saturable portions 210 and 211 are saturated first, and then the rotor 202 rotates in the same direction as that described above by 180° by a mutual action between a magnetic pole generated in the stator 201 and a magnetic pole of the rotor 202, and stops stably at the predetermined angular position θ1.

In this manner, by supplying the signals having different polarities (alternating signals) to the coil 209, the operation is repeatedly performed, so that the rotor 202 is rotated continuously in the normal direction by 180° each. In this embodiment, a plurality of main driving pulses P10 to P1m and the correction driving pulse P2 having energies different from each other are used as the driving pulses as described later.

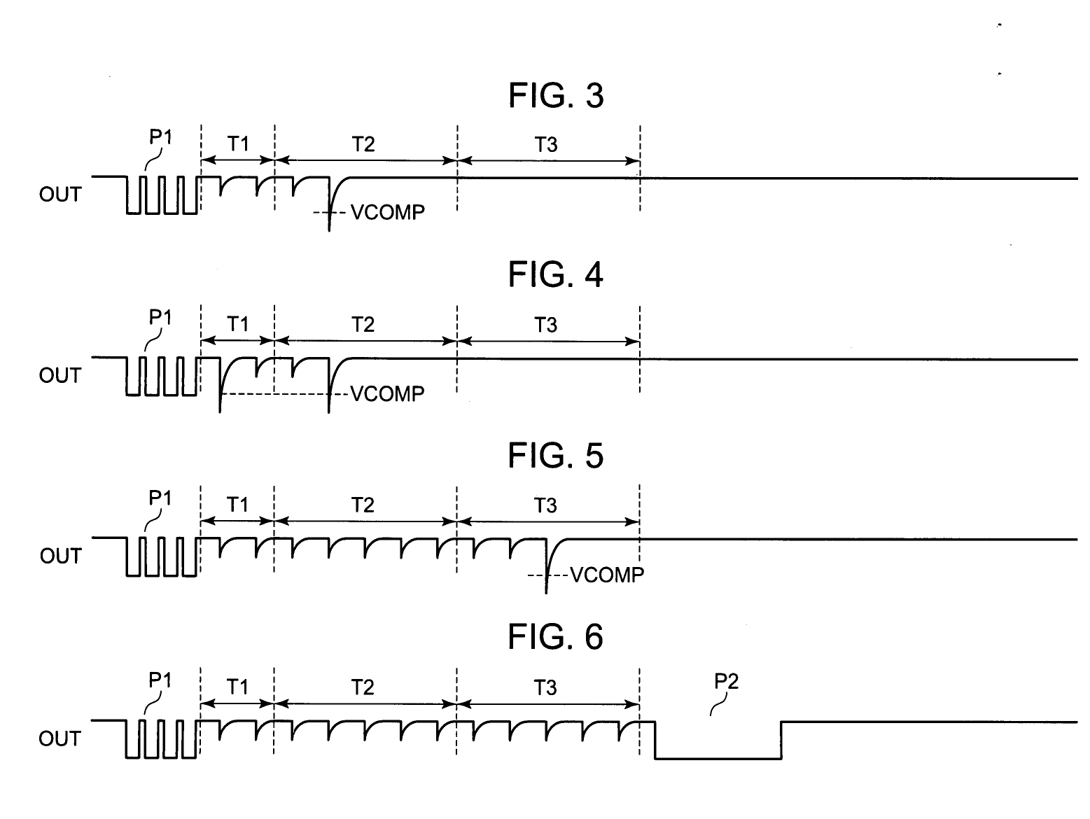

FIG. 3 to FIG. 7 are timing charts showing driving timings of the stepping motor 108, rotation detecting timings, and the types of the driving pulses used therefor, and are timing charts in a case where the stepping motor 108 is driven by the main driving pulse P1 and the correction driving pulse P2 in this embodiment. In this embodiment, a comb-shaped pulse is used as the main driving pulse P1.

A rotation detecting period for detecting whether the stepping motor 108 is rotated or not is provided immediately after the driving period in which the stepping motor 108 is driven by the main driving pulse P1. The rotation detecting period is divided into a plurality of segments.

In this embodiment, the rotation detecting period is divided into the three segments (a first segment T1 for detecting an induced signal VRs generated at least in a second quadrant II by the rotation of the rotor 202 immediately after the driving of the main driving pulse P1, a second segment T2 being provided after the first segment T1 for detecting the induced signal VRs in a third quadrant III, and a third segment T3 provided after the second segment T2), so that the state of rotation of the stepping motor 108 is determined on the basis of the segment from among the segments T1 to T3 where the induced signal VRs exceeding the reference threshold voltage Vcomp is detected thereby controlling the drive of the stepping motor 108 by the adequate driving pulse (pulse control). The detected result in the segments T1 to T3 is also used for the output control of the pulse down control signal of the pulse down counter circuit 103.

In FIG. 3, the main driving pulse P1 is outputted from the main driving pulse generating circuit 105 by the control of the control circuit 104, and the rotation of the stepping motor 108 is driven by the motor driver circuit 107. In this example, the induced signal VRs exceeding the predetermined reference threshold voltage Vcomp is detected by the rotation detecting circuit 109 only in the segment T2 from among the segments T1 to T3, so that the control circuit 104 determines that the stepping motor 108 is in rotation, but the driving energy of the main driving pulse P1 is excessive (rotation with reserved capacity).

In this case, the control circuit 104 changes the driving energy to the main driving pulse P1 which is one rank lower (pulse down) at the time of driving after a predetermined time period for driving, and hence does not prohibit the pulse down counter circuit 103 from outputting the pulse down control signal. Therefore, when the predetermined cycle arrives, the pulse down counter circuit 103 outputs the pulse down control signal for performing the pulse down operation on the driving energy of the main driving pulse P1 by one rank to the main driving pulse generating circuit 105. The main driving pulse generating circuit 105 performs the pulse down operation on the main driving pulse P1 by one rank in response to the pulse down control signal, and controls the rotation of the motor 108 by the main driving pulse P1 via the motor driver circuit 107.

FIG. 4 shows an example of a case where the rotation detecting circuit 109 detects the induced signal VRs exceeding the reference threshold voltage Vcomp in the first segment T1 and the second segment T2 when the stepping motor 108 is driven by the main driving pulse P1 in this embodiment.

In this case, the control circuit 104 determines that the stepping motor 108 is in rotation and the driving energy of the main driving pulse P1 is optimal (rotation without reserved capacity), and controls the main driving pulse generating circuit 105 so as to perform the subsequent driving by the same main driving pulse P1. At the same time, the control circuit 104 also controls the pulse down counter circuit 103 not to output the pulse down control signal even when the pulse down counter circuit 103 counts the predetermined cycle. Accordingly, since the pulse down counter circuit 103 does not output the pulse down control signal to the main driving pulse generating circuit 105, the pulse down of the main driving pulse P1 is not achieved.

FIG. 5 shows an example of a case where the rotation detecting circuit 109 detects the induced signal exceeding the reference threshold voltage Vcomp only in the third segment T3 when the stepping motor 108 is driven by the main driving pulse P1 in this embodiment.

In this case, the control circuit 104 determines that the stepping motor 108 is in rotation, but the driving energy of the main driving pulse P1 is not sufficient (critical rotation), so that the state of no-rotation may occur at the time of the subsequent driving by the same main driving pulse P1, and hence controls the main driving pulse generating circuit 105 so as to drive with the main driving pulse P1 in which the driving energy is moved up by one rank (pulse up) at the time of the subsequent driving without driving by the correction driving pulse P2.

At the same time, the control circuit 104 also controls the pulse down counter circuit 103 not to output the pulse down control signal even when the pulse down counter circuit 103 counts the predetermined cycle. Accordingly, since the pulse down counter circuit 103 does not output the pulse down control signal to the main driving pulse generating circuit 105, the pulse down of the main driving pulse P1 is prohibited.

FIG. 6 shows an example of a case where the rotation detecting circuit 109 does not detect any induced signal exceeding the reference threshold voltage Vcomp in any of the first segment T1 to the third segment T3 when the stepping motor 108 is driven by the main driving pulse P1 in this embodiment.

In this case, the control circuit 104 determines that the stepping motor 108 is not in rotation, and hence the driving energy of the main driving pulse P1 is not sufficient (no-rotation), and hence controls the correction driving pulse generating circuit 106 so as to forcedly drive the rotation of the stepping motor 108 by the correction driving pulse P2 and then controls the main driving pulse generating circuit 105 so that the stepping motor is driven by the main driving pulse P1 having the driving energy moved up by one rank at the time of the subsequent driving. Accordingly, the correction driving pulse generating circuit 106 drives the stepping motor 108 by the correction driving pulse P2, and the main driving pulse generating circuit 105 drives the same by the main driving pulse P1, which is moved up by one rank at the time of the subsequent driving.

At the same time, the control circuit 104 also controls the pulse down counter circuit 103 not to output the pulse down control signal even when the pulse down counter circuit 103 counts the predetermined cycle. Accordingly, since the pulse down counter circuit 103 does not output the pulse down control signal to the main driving pulse generating circuit 105, the pulse down of the main driving pulse P1 is not achieved.

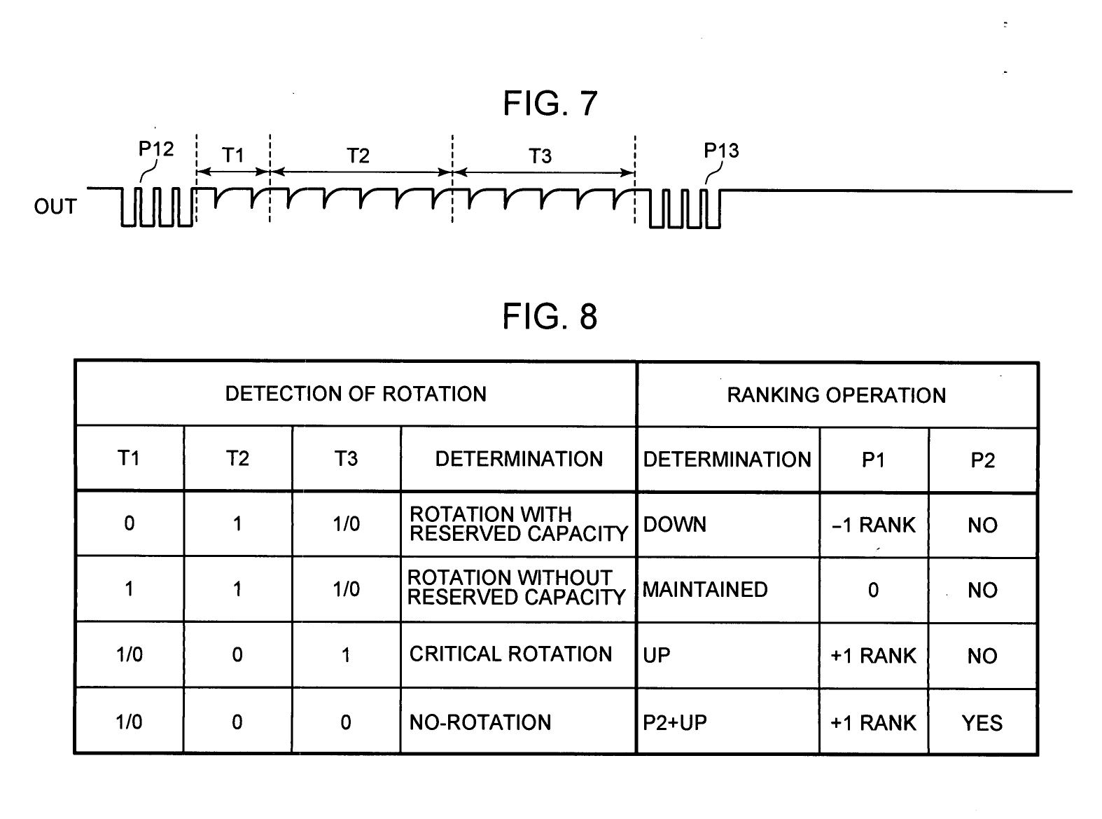

FIG. 7 is a timing chart showing a case where the rotation detecting circuit 109 does not detect the induced signal exceeding the reference threshold voltage Vcomp in any of the first segment T1 to the third segment T3 as in FIG. 6, and is an example, in which the stepping motor 108 is driven by a main driving pulse P12 which is the main driving pulse moved down by one rank from a main driving pulse P13, and then driven by the main driving pulse P13 before the pulse down as described later.

The relationship of the driven-to-rotate period and the rotation detecting period with the rotational operation of the stepping motor 108 will be described with reference to FIG. 2. When an area driven by the main driving pulse is designated as a, an induced signal generated in a range a′ in the second quadrant II is detected as a positive polarity in the first segment T1, an induced signal generated in a range b of the third quadrant III is detected in an opposite polarity across the first segment T1 and the second segment T2, and an induced signal generated in a range c of the third quadrant III is detected in the positive polarity in the third segment T3 (the reserved capacity of the driving energy is larger when being detected in the second segment T2 than the third segment T3).

In other words, since the induced signal VRs is generated by the vibrations of the rotor after having ended the driving pulse, the timing when the induced signal induced by the first segment T1 is limited to an area from a state of being driven to rotate without any reserved force (almost stopped) to a state having a reserved capacity for driving to some extent, and is characterized by not being generated when a sufficient rotational force is present (the area a′ in FIG. 2 corresponds to this state).

When the sufficient reserved drive force is remained, since the driving pulse is ended in the area b, the outputted induced signal has an opposite phase. The height of the induced signal in the first segment T1 is reversely proportional to the reduction of the reserved drive force by the movement of the rotor 202. In this manner, the degree of the reserved capacity for driving is determined.

In view of such the characteristic, in this embodiment, when the induced signal exceeding the reference threshold voltage Vcomp is generated in the first segment T1, it is determined that the reserved force for the rotation is reduced, so that the pulse down counter circuit 103 maintains the pulse without performing the pulse down operation and does not change the driving pulse to the one having a smaller energy.

FIG. 8 is a determination chart showing the relationship of the result of detection of rotation with the ranking operation of the driving pulse including the above-described relationship.

In FIG. 8, when the induced signal exceeding the reference threshold voltage Vcomp is detected only in the second segment T2, or only in the T2 and the T3, it is determined to be the rotation having the reserved capacity in driving energy (rotation with reserved capacity), and the main driving pulse P1 is moved down by one rank.

When the induced signal exceeding the reference threshold voltage Vcomp is detected in all of the segments T1 to T3, or only in the segments T1 and T2 (at least the segments T1 and T2), it is determined to be the rotation without the reserved capacity to move the driving energy down in ranks (rotation without reserved capacity), and the main driving pulse P1 is maintained in status quo without being changed.

When the induced signal exceeding the reference threshold voltage Vcomp is detected only in the segments T1 and T3, or only in the segment T3, it is determined to be the rotation having the critical driving energy (critical rotation), so that the main driving pulse P1 is moved up by one rank.

When the induced signal exceeding the reference threshold voltage Vcomp is detected only in the segment T1, or not detected in any of the segments T1 to T3, it is determined to be the no-rotation so that the stepping motor 108 is driven by the correction driving pulse P2, and then the main driving pulse P1 is moved up by one rank.

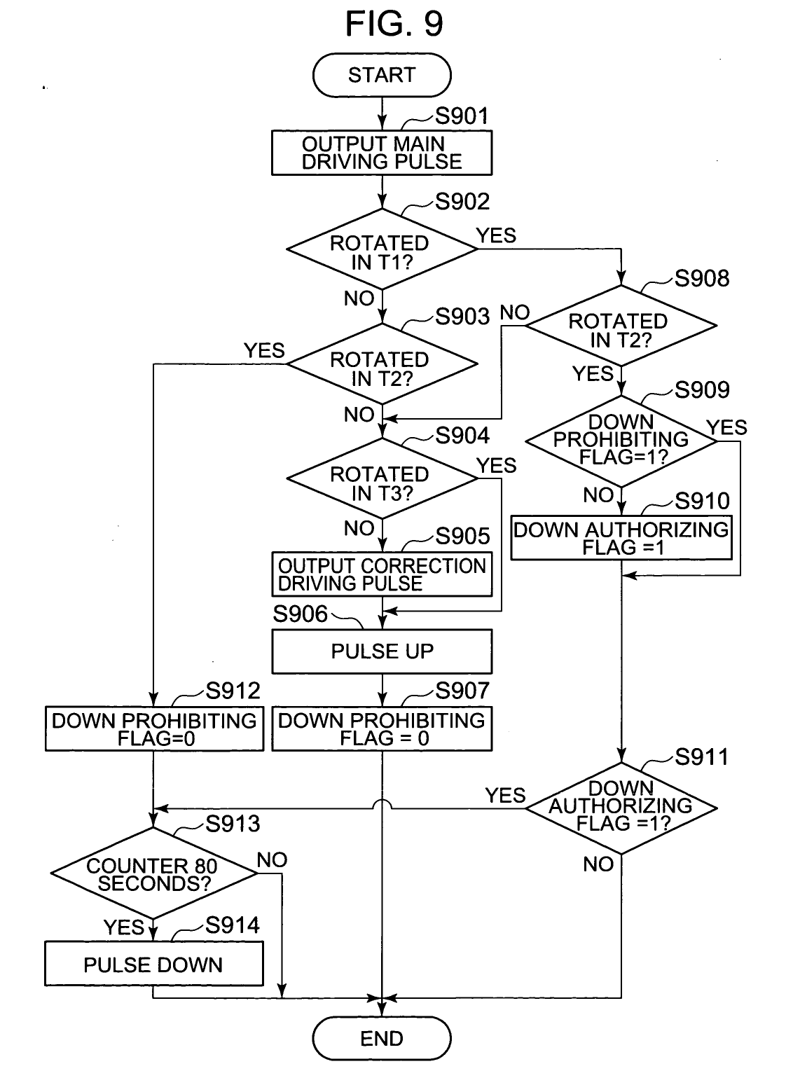

FIG. 9 is a flowchart showing the action of the stepping motor control circuit and the analogue electronic watch according to the embodiment of the invention, and is a flowchart of a portion relating to the control of the pulse down counter circuit 103.

The process shown in FIG. 9 is a flow of a sequence performed under normal conditions, and when the detection pattern (the first segment T1, the second segment T2, and the third segment T3) of the induced signal VRs that the rotation detecting circuit 109 detects in the detecting period becomes a combination of (1, 1, 1/0), (“1/0” means “any of them”), the control circuit 104 sets a down authorizing flag in the interior of the control circuit 104 to “1” for confirming that the detection pattern is really the (1, 1, 1/0), and performs the pulse down operation on the main driving pulse P1 only once after having elapsed a predetermined time period (80 seconds in this embodiment) by the bifurcation of the process step S911.

Here, the down authorizing flag is a flag to be set to “1” when the detection pattern becomes the combination of (1, 1, 1/0), and to be set to “0” when the pulse down operation is performed on the main driving pulse P1 once. A down prohibiting flag is a flag to be set to “1” when the pulse down operation is performed once, and to be set to “1” when the detection pattern becomes a combination other than (1, 1, 1/0).

Referring now to FIG. 1 to FIG. 9, the action of the stepping motor control circuit and the analogue electronic watch according to the embodiment of the invention will be described in detail.

In FIG. 1, the oscillating circuit 101 generates a signal of a predetermined frequency, and the dividing circuit 102 divides the signal generated by the oscillating circuit 101 and generates a clock signal as a reference of time counting and outputs the same to the pulse down counter circuit 103 and the control circuit 104.

The pulse down counter circuit 103 performs a time counting action by counting the clock signal from the dividing circuit 102, and starts operating to output the pulse down control signal to the main driving pulse generating circuit 105 every time when the predetermined cycle is elapsed.

The control circuit 104 outputs the main driving pulse control signal to the main driving pulse generating circuit 105 so as to drive the stepping motor 108 to rotate by the main driving pulse P1 having a predetermined energy (Step S901). The main driving pulse generating circuit 105 outputs the main driving pulse P1 of the predetermined energy to the motor driver circuit 107 in response to the main driving pulse control signal. The motor driver circuit 107 drives the stepping motor 108 to rotate by the main driving pulse P1. The stepping motor 108 is driven to rotate by the main driving pulse P1 and drives the display device 110. Accordingly, since the stepping motor 108 is configured to rotate reliably by the main driving pulse P1 when it is functioning normally, a current time display or the like by the time-of-day hands is normally achieved by the display device 110.

The rotation detecting circuit 109 informs the fact that the induced signal exceeding the reference threshold voltage Vcomp is detected immediately to the control circuit 104 when it is detected.

When the control circuit 104 determines that the rotation detecting circuit 109 does not detect the induced signal VRs exceeding the reference threshold voltage Vcomp in any of the first segment T1, the second segment T2, and the third segment T3 (the stepping motor 108 is not rotated in any of the first segment T1, the second segment T2, and the third segment T3) (the detection pattern is (0, 0, 0)), that is, determines that the stepping motor 108 is not rotating, (Steps S902, S903, S904), the control circuit 104 outputs the correction driving pulse control signal to the correction driving pulse generating circuit 106 and controls the same to output the correction driving pulse P2 (Step S905).

The correction driving pulse generating circuit 106 outputs the correction driving pulse P2 to the motor driver circuit 107 in response to the correction driving pulse control signal.

The motor driver circuit 107 drives the stepping motor 108 to rotate by the correction driving pulse P2. The stepping motor 108 is forcedly driven to rotate by the correction driving pulse P2 and drives the display device 110. Accordingly, the stepping motor 108 is forcedly rotated, and the current time display or the like by the time-of-day hands is achieved by the display device 110.

At the same time, the control circuit 104 outputs a pulse up control signal to the main driving pulse generating circuit 105 to control the main driving pulse P1 to move up by one rank (Step S906), and then sets the down prohibiting flag provided in the control circuit 104 to “0” (Step S907).

When the control circuit 104 determines that the rotation detecting circuit 109 detects the induced signal VRs exceeding the reference threshold voltage Vcomp (the detection pattern is (0, 0, 1)) in the third segment T3 in a process step S904, that is, determines that the rotation is the critical rotation, the procedure goes to a process step S906 without outputting the correction driving pulse P2, where the pulse is gotten up.

When the control circuit 104 determines that the rotation detecting circuit 109 detects the induced signal VRs exceeding the reference threshold voltage Vcomp (the detection pattern is (0, 1, 1/0)) in the second segment T2 in a process step S903, that is, determines that the rotation is the rotation with the reserved capacity, the control circuit 104 sets the down prohibiting flag to “0” to allow the pulse down (Step S912).

Subsequently, the control circuit 104 performs the pulse down operation on the main driving pulse P1 to move the same down to the main driving pulse P1 which is smaller by one rank when the counter in the control circuit 104 counts a predetermined time period (80 seconds in this embodiment), and the procedures goes back to a process step S901 in a state in which the counter in the control circuit 104 does not count 80 seconds (Step S913, Step S914). Accordingly, the pulse down control at every predetermined time period is performed when there is the reserved capacity for driving.

In contrast, in a case where the control circuit 104 determines that the rotation detecting circuit 109 detects the induced signal VRs exceeding the reference threshold voltage Vcomp in the first segment T1 in a process step S902, and if the control circuit 104 determines that the induced signal VRs exceeding the reference threshold voltage Vcomp is not detected in the second segment T2, the procedure goes to the process step S904 (Step S908).

When the control circuit 104 determines that the rotation detecting circuit 109 detects the induced signal VRs exceeding the reference threshold voltage Vcomp in the second segment T2 (the detection pattern is (1, 1, 1/0) in a process step S908, if the down prohibiting flag is not set to “1”, the down authorizing flag to “1” and then the procedure goes to the process step S911, and, if the down prohibiting flag is set to “1”, the procedure goes immediately to the process step S911 (Steps S909, S910).

When the control circuit 104 determines that the down prohibiting flag is not set to “1” in the process step S911, the control circuit 104 returns the process step S901, and when it determines that the down authorizing flag is set to 1″, the procedure goes to a process step S913, where the pulse down is performed after the predetermined time period has elapsed.

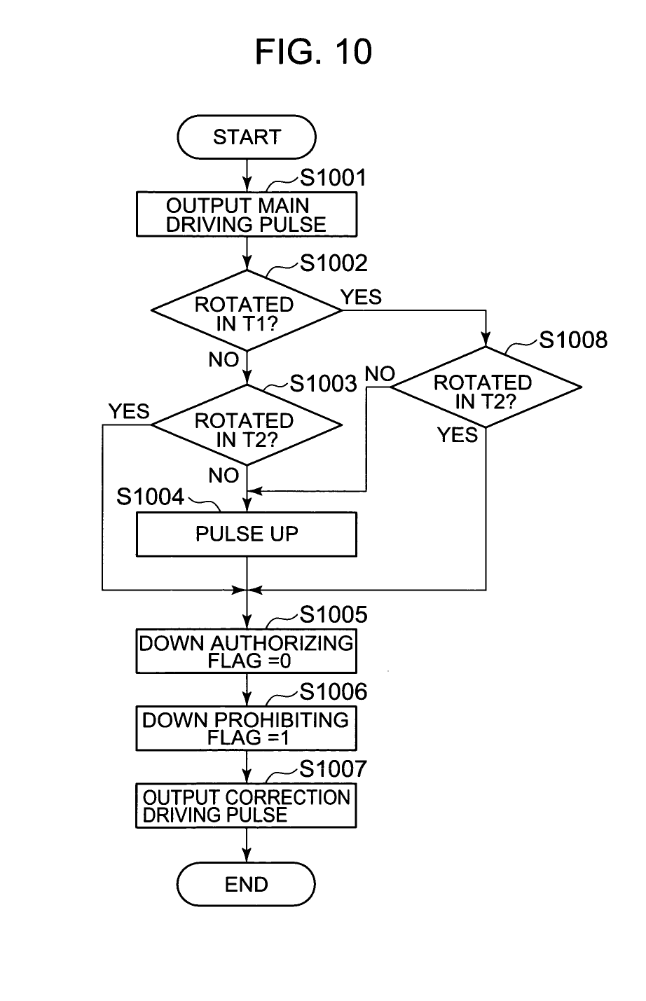

FIG. 10 is a flowchart showing the action of the stepping motor control circuit and the analogue electronic watch according to the embodiment of the invention, and is a flowchart of a portion relating to the control of the pulse down counter circuit 103.

The process in FIG. 10 is a process flow for performing the pulse down only once when the detection pattern in the combination of (1, 1, 1/0) is detected in order to confirm that the detection pattern is not (0, 1, 1/0), but is (1, 1, 1/0). Whether or not the pulse is gotten up to the original main driving pulse by the combination of the detected result in the first segment T1 and the second segment T2, and the correction driving pulse P2 is always used for driving and the down prohibiting flag is set to “1” to prohibit the pulse down.

In FIG. 10, the control circuit 104 outputs the main driving pulse control signal to the main driving pulse generating circuit 105 so as to drive the stepping motor 108 to rotate by the main driving pulse P1 having a predetermined energy (Step S1001). The main driving pulse generating circuit 105 outputs the main driving pulse P1 having the predetermined energy to the motor driver circuit 107 in response to the main driving pulse control signal. The motor driver circuit 107 drives the stepping motor 108 to rotate by the main driving pulse P1. The stepping motor 108 is driven to rotate by the main driving pulse P1 and drives the display device 110. Accordingly, since the stepping motor 108 is configured to rotate reliably by the main driving pulse P1 when it is functioning normally, the current time display or the like by the time-of-day hands is normally achieved by the display device 110.

When the control circuit 104 determines that the rotation detecting circuit 109 does not detect the induced signal VRs exceeding the reference threshold voltage Vcomp in any of the first segment T1 and the second segment T2 (the detection pattern is (0, 0, 1/0)), that is, determines that the stepping motor 108 is in critical rotation or is not rotating, (Steps S1002, S1003), the control circuit 104 outputs the main driving pulse control signal to the main driving pulse generating circuit 105 so that the main driving pulse P1 is moved up by one rank (the pulse is gotten up to the main driving pulse P1 before performing the pulse down for trial) (Step S1004).

Subsequently, the control circuit 104 sets the down authorizing flag to “0” (Step S1005), then sets the down prohibiting flag to “1” (Step S1006), and then outputs the correction driving pulse control signal to the correction driving pulse generating circuit 106 so as to drive the stepping motor 108 by the correction driving pulse P2 for control (Step S1007).

The correction driving pulse generating circuit 106 outputs the correction driving pulse P2 to the motor driver circuit 107 in response to the correction driving pulse control signal. The motor driver circuit 107 drives the stepping motor 108 to rotate by the correction driving pulse P2. Accordingly, the stepping motor 108 can be reliably rotated even when it cannot be driven to rotate when an attempt is made to drive after having performed the pulse down operation for the trial.

In a process step S1007, the main driving pulse before performing the pulse down operation may be used for driving instead of the correction driving pulse P2 as shown in FIG. 7. This also enables the reliably driving of rotation.

When the control circuit 104 determines that the rotation detecting circuit 109 detects the induced signal VRs exceeding the reference threshold voltage Vcomp (the detection pattern is (0, 1, 1/0)) in the second segment T2 in a process step S1003, that is, determines that the rotation is the rotation with the reserved capacity, the control circuit 104 proceeds to a process step S1005 without getting the pulse up.

In contrast, in a case where the control circuit 104 determines that the rotation detecting circuit 109 detects the induced signal VRs exceeding the reference threshold voltage Vcomp in the first segment T1 in a process step S1002, if the rotation detecting circuit 109 does not detect the induced signal VRs exceeding the reference threshold voltage Vcomp in the second segment T2, the procedure goes to a process step 1004 for the pulse-up, and if the rotation detecting circuit 109 detects the induced signal VRs exceeding the reference threshold voltage Vcomp in the second segment T2 (the detection pattern is (1, 1, 1/0)), it is determined that the rotation has no reserved capacity and the procedure goes to the process step S1005 without getting the pulse up (Step S1008).

As described above, according to the stepping motor control circuit according to another embodiment of the invention, the rotation detecting period is divided into the first segment T1 for detecting the induced signal VRs generated at least in the second quadrant II by the rotation of the rotor 202 immediately after the driving of the main driving pulse P1, the second segment T2 being provided after the first segment T1 for detecting the induced signal VRs in the third quadrant III, and the third segment T3 provided after the second segment T2 and, when the rotation detecting circuit 109 detects the induced signal VRs exceeding the reference threshold voltage Vcomp in the first segment T1 and the second segment T2 (the detected pattern is (1, 1, 1/0)), the control circuit 104 controls the pulse down counter circuit 103 to output the pulse down control signal.

In this manner, even when the stepping motor 108 is driven by the main driving pulse and it is determined that there is no reserved capacity for driving as a result of detection of the rotation, the subsequent pulse down is allowed only once, and the reserved capacity for driving is determined with the main driving pulse moved down by one rank and, when it is determined that the rotation is possible, the correction driving pulse is outputted while maintaining the current pulse rank. When it is determined that the rotation is critical, the pulse is moved up by one rank, and the correction driving pulse is outputted.

Therefore, the driving state of the stepping motor is accurately grasped, so that power saving is achieved.

Even when the short of the reserved capacity for driving is determined to early even though the main driving pulse of one rank lower is also sufficient for driving due to the variations among the stepping motors or variations in gear train load, since whether or not the rotation is possible with the main driving pulse of one rank lower can be determined, so that effects such as the prevention of the useless power consumption is advantageously achieved.

Since the stepping motor is driven by the correction driving pulse after having been driven by the main driving pulse after having subjected to the pulse down for the confirmation, reliable rotation is achieved even when the no-rotation is resulted due to the pulse down.

According to the embodiment, the analogue electronic watch which achieves power saving is provided by grasping the driving state of the stepping motor accurately.

In the respective embodiments described above, the energy of the respective main driving pulses P1 is changed by differentiating the pulse width. However, the driving energy can be changed also by changing the pulse voltage.

The invention is also applicable to the stepping motor for driving a calendar or the like instead of the time-of-day hands.

Also, although the analogue electronic watch has been described as the example of the application of the stepping motor, it may be applicable to electronic instruments which use the motor.

The stepping motor control circuit according to the invention may be applicable to various electronic instruments using the stepping motor.

The electronic watch according to the invention is applicable to various analogue electronic clocks with a calendar function such as analogue electronic standing clocks with a calendar functions or analogue electronic watches with a calendar function, as well as various analogue electronic clocks.

What is claimed is:

1. A stepping motor control circuit comprising:
a pulse down counter circuit configured to output a pulse down control signal for pulse down controlling of a main driving pulse at a predetermined cycle;
a driving pulse generating unit configured to output the main driving pulse or a correction driving pulse corresponding to a pulse control signal, and perform a pulse down operation on the main driving pulse in response to the pulse down control signal;
a motor driving unit configured to drive a stepping motor to rotate in response to the driving pulse from the driving pulse generating unit;
a rotation detecting unit configured to detect whether or not an induced signal generated within a rotation detecting period by the rotation of the stepping motor exceeds a reference threshold voltage; and
a control unit configured to output the pulse control signal for controlling the driving pulse generating unit so as to drive the stepping motor by any one of a plurality of the main driving pulses different in energy from each other or the correction driving pulse having a larger energy than the respective main driving pulses on the basis of the result of detection by the rotation detecting unit, wherein
the rotation detecting period is divided into a first segment for detecting the induced signal generated in at least a second quadrant, a second segment being provided after the first segment for detecting the induced signal in a third quadrant, and a third segment being provided after the second segment according to the rotation of the rotor immediately after the driving by the main pulse,
the control unit controls the pulse down counter circuit so as to be able to output the pulse down control signal only once when the rotation detecting unit detects an induced signal exceeding the reference threshold voltage in the first segment and the second segment, and
the driving pulse generating unit outputs the main driving pulse having subjected to the pulse down operation in response to the pulse down control signal from the pulse down counter circuit to the motor driving unit.

2. A stepping motor control circuit according to claim 1, wherein the control unit controls the pulse down counter circuit to output the pulse down control signal when the rotation detecting unit detects the induced signal exceeding the reference threshold voltage in the first segment and the second segment, and outputs the pulse control signal to the driving pulse generating unit to cause the same to output the correction driving pulse,
the driving pulse generating unit outputs the main driving pulse having subjected to the pulse down operation in response to the pulse down control signal to the motor driving unit and then outputs the correction driving pulse, and
the motor driving unit drives the stepping motor by the main driving pulse in response to the main driving pulse and the correction driving pulse from the driving pulse generating unit, and then drives the same by the correction driving pulse.

3. A stepping motor control circuit according to claim 2, wherein the control unit outputs the pulse control signal to the driving pulse generating unit so as to output the main driving pulse before the pulse down instead of the correction driving pulse,
the driving pulse generating unit outputs the main driving pulse having subjected to the pulse down operation in response to the pulse down control signal to the motor driving unit and then outputs the main driving pulse before the pulse down, and
the motor driving unit drives the stepping motor by the main driving pulse having subjected to the pulse down operation and then drives the same by the main driving pulse before the pulse down.

4. An analogue electronic watch having a stepping motor configured to drive time-of-day hands to rotate, and a stepping motor control circuit configured to control the stepping motor, wherein the stepping motor control circuit according to claim 1 is used as the stepping motor control circuit.

5. An analogue electronic watch having a stepping motor configured to drive time-of-day hands to rotate, and a stepping motor control circuit configured to control the stepping motor, wherein the stepping motor control circuit according to claim 2 is used as the stepping motor control circuit.

6. An analogue electronic watch having a stepping motor configured to drive time-of-day hands to rotate, and a stepping motor control circuit configured to control the stepping motor, wherein the stepping motor control circuit according to claim 3 is used as the stepping motor control circuit.
